(19) United States
(12) Patent Application Publication
(10) Pub. No.: US 2025/0150811 A1
(43) Pub. Date: May 8, 2025

(54) METHOD OF COMMUNICATION BETWEEN A TRANSMITTER AND A RECEIVER AND CORRESPONDING SYSTEM INCLUDING A TRANSMITTER AND A RECEIVER

(71) Applicant: STMicroelectronics International N.V., Geneva (CH)

(72) Inventor: Julien SAADE, Toulon (FR)

(73) Assignee: STMicroelectronics International N.V., Geneva (CH)

(21) Appl. No.: 18/935,075

(22) Filed: Nov. 1, 2024

(30) Foreign Application Priority Data
Nov. 3, 2023 (FR) 2311970

(51) Int. Cl. H04W 12/03; H04L 9/08; H04W 12/04

(52) U.S. Cl. CPC H04W 12/03; H04L 9/0841; H04W 12/04

(57) ABSTRACT

At least one transmission of scrambled data with a pseudo-random sequence generated by a scrambling polynomial and an initialization value is performed between a transmitter and a receiver. Prior to the transmission, transmitter and the receiver engage in a secret negotiation phase to specifically determine the scrambling polynomial and the initialization value for the at least one transmission.

### PRIORITY CLAIM

This application claims the priority benefit of French Application for Patent No. 2311970 filed on Nov. 3, 2023, the content of which is hereby incorporated by reference in its entirety to the maximum extent allowable by law.

### TECHNICAL CLAIM

Embodiments and implementations relate to communications between a transmitter and a receiver, particularly “chip-to-chip” communications, that is to say communications between integrated circuits, using a scrambling of data.

### BACKGROUND

Scrambling is widely used in communications for randomizing the data communicated before the transmission.

Scrambling forms part of the line coding that is the last operation on the data before they are sent over the communication channel by the transmitter.

Scrambling is typically an “XOR” (exclusive-or) operation between the clear data and a pseudo-random dataset, typically obtained with a Linear Feedback Shift Register (LFSR). The data thus scrambled are transmitted over the channel, and the clear data can be retrieved by the reverse operation, that is to say the same XOR operation with the same pseudo-random dataset.

The pseudo-random dataset generated by an LFSR is typically characterized by the retroaction polynomial of the LFSR, also called scrambling polynomial, and by an initialization value of the register.

In order to retrieve the clear data, the scrambling polynomial and the initialization value must be known by the receiver before transmitting the data, which exposes conventional systems to two problems: sniffing attacks and killer packet attacks.

Briefly stated, sniffing attacks correspond to the case where a confidentiality is required in the scrambling of data, whereas a third party may relatively easily have knowledge of the scrambling polynomial and of the initialization value, and thus retrieve the clear data over the channel.

Killer packet attacks correspond to a design of raw data packets such that once aligned on the output of the LFSR, consecutive sequences of 0 or of 1 are produced and are likely to result in continuous errors on the receiver and make the system malfunction.

Conventionally, to protect against errors due to killer packet attacks, a new attempt of sending data is carried out by changing the polynomial and/or initialization, when the recipient detects an error. However, this conventional mechanism has the drawback of taking time and does not make it possible to protect against a new design of killer packets adapted to the new polynomial and/or initialization conditions.

The encryption of the data of the communication is a complex solution that requires complex cryptographic algorithms that are time and energy consuming.

Thus, there is a need to provide a protection over the communication channels, for example of the chip-to-chip type, in particular against sniffing and killer packet attacks, and advantageously in a resource, implementation time, and energy-saving manner.

### SUMMARY

Implementations and embodiments described herein make it possible to secure the secret of the scrambling polynomial and of the initialization value, so that the confidentiality obtained by scrambling the data communicated over the channel is resistant against the attacks, particularly sniffing and killer packet type attacks, based on obtaining the polynomial and the initialization.

According to one aspect, a method of communication between a transmitter and a receiver is proposed comprising at least one transmission of scrambled data with a pseudo-random sequence generated by a scrambling polynomial and an initialization value, the method comprising engaging in a secret negotiation phase between the transmitter and the receiver to specifically determine the scrambling polynomial and the initialization value for said at least one transmission.

Thus, as opposed to conventional techniques where the scrambling polynomial and the initialization value are predetermined for the entire communication, in this aspect a scrambling polynomial and the initialization value are specifically and secretly determined by the negotiation phase for each subset of (at least one) transmission(s) of said communication.

According to one implementation, engaging in the secret negotiation phase includes exchanging encrypted information between the transmitter and the receiver, the encrypted information making it possible to specifically determine the scrambling polynomial and the initialization value by the transmitter and by the receiver.

The encryption of the negotiation phase, potentially with complex cryptographic solutions, is not (or only marginally) subjected to the problem of time and energy consumption, due to the fact that the amount of information exchanged in the negotiation phase is very small, particularly negligible in relation to the amount of data communicated.

According to one implementation, the scrambling polynomial is determined by selecting in a finite set of scrambling polynomials available to the transmitter and to the receiver, the selection being made depending on conditions contained in said encrypted information.

The conditions for the selection may be chosen jointly for the transmitter and the receiver, for example arbitrary conditions of parity or of intervals of values of a digital datum, or of a portion of the digital datum, contained in said encrypted information.

According to one implementation, the initialization value is contained directly or indirectly in said encrypted information.

For example, the initialization value may be communicated directly in a digital datum or in a portion of the digital datum, contained in said encrypted information; or communicated indirectly, for example derived by a computing method chosen jointly for the transmitter and the receiver from a digital datum or from a portion of the digital datum, contained in said encrypted information.

According to one implementation, engaging in the secret negotiation phase includes performing a Diffie-Hellmann key exchange, for example possibly based on elliptic curves, so as to develop a shared secret making it possible to determine the scrambling polynomial and the initialization value.

For example, the shared secret forms part of said encrypted information, exchanged between the transmitter and the receiver by the key exchange mechanism, making it possible to specifically determine the scrambling polynomial and the initialization value by the transmitter and by the receiver.

According to one implementation, engaging in the secret negotiation phase includes engaging in an encrypted communication of the Rijndael type, also referred to as an advanced encryption standard, containing the determination of the scrambling polynomial and of the initialization value.

For example, the encrypted communication of the Rijndael type forms part of said encrypted information making it possible to specifically determine the scrambling polynomial and the initialization value by the transmitter and by the receiver.

According to another aspect, a system includes: a transmitter and a receiver configured to implement a communication comprising at least one transmission of scrambled data with a pseudo-random sequence generated by a scrambling polynomial and an initialization value, wherein the transmitter and receiver engage in a secret negotiation phase to specifically determine the scrambling polynomial and the initialization value for said at least one transmission.

According to one embodiment, the transmitter and the receiver are configured, in the secret negotiation phase, to exchange encrypted information making it possible to specifically determine the scrambling polynomial and the initialization value by the transmitter and by the receiver.

According to one embodiment, the transmitter and the receiver are configured to have available a finite set of scrambling polynomials, and to determine the scrambling polynomial by selecting it in said set depending on conditions contained in said encrypted information.

According to one embodiment, the transmitter and the receiver are configured to exchange said encrypted information directly or indirectly containing the initialization value.

According to one embodiment, the transmitter and the receiver are configured, in the secret negotiation phase, to carry out a Diffie-Hellmann key exchange, for example possibly based on elliptic curves, so as to develop a shared secret making it possible to determine the scrambling polynomial and the initialization value.

According to one embodiment, the transmitter and the receiver are configured, in the secret negotiation phase, to carry out an encrypted communication of the Rijndael type containing the determination of the scrambling polynomial and of the initialization value.

According to another aspect, a transmitter device is configured to implement a communication, with a receiver, comprising at least one transmission of scrambled data with a pseudo-random sequence generated by a scrambling polynomial and an initialization value, and engage in a secret negotiation phase with the receiver to specifically determine the scrambling polynomial and the initialization value for said at least one transmission.

According to another aspect, a receiver device is configured to implement a communication, with a transmitter, comprising at least one transmission of scrambled data with a pseudo-random sequence generated by a scrambling polynomial and an initialization value, and engage in a secret negotiation phase with the transmitter to specifically determine the scrambling polynomial and the initialization value for said at least one transmission.

The transmitter device and the receiver device such as defined independently above, may be capable of belonging to a system such as defined above, that is to say further include all of the elements respectively characterizing the transmitter and the receiver of a system such as defined above.

### BRIEF DESCRIPTION OF THE DRAWINGS

Other advantages and features of the invention will become apparent upon examining the detailed description of non-limiting embodiments and implementations, and from the appended drawings, wherein figures:

FIG. 1 illustrates an example of system including a transmitter and a receiver configured to implement a communication over a communication channel;

FIG. 2 illustrates a first example of the method of communication between the transmitter and the receiver of the system described above in relation to FIG. 1; and

FIG. 3 illustrates a second example of the method of communication between the transmitter and the receiver of the system described above in relation to FIG. 1.

### DETAILED DESCRIPTION

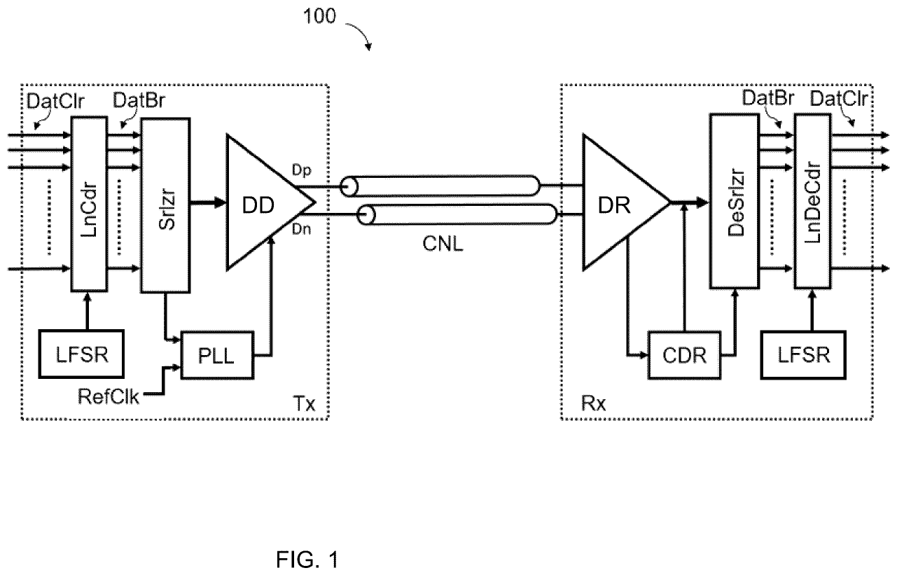

FIG. 1 illustrates an example of system 100 including a transmitter Tx and a receiver Rx configured to implement a communication over a communication channel CNL.

The transmitter Tx and the receiver Rx are, for example, integrated devices of integrated circuits, otherwise known as chips. The channel CNL is, for example, a quick link, having a throughput at several gigabits per second, and for example on two differential lines Dp, Dn.

An output stage of the transmitter Tx receives raw or clear data DatClr (i.e. not scrambled), at the same time with a throughput at, for example, several megabits per seconds, and coming from the intelligence of the transmitter device TX, for example usually a processor or an automaton of the state machine type.

A line coder LnCdr is configured to convert (encode) the raw data DatClr into the coding used in the communication protocol of the channel CNL, and is further configured to introduce scrambling into the values of the raw data DatClr, thus communicating scrambled and encoded data DatBr.

Line coding LnCdr is substantially the last operation before the data DatBr are serialized by a serializer Srlzr, and sent over the channel CNL typically via a differential driver DD).

The differential driver is, for example, clocked by a signal at a frequency adapted to the channel CNL (several gigabits/sec) typically generated from a reference clock RefClk in a phase-locked loop PLL.

Scrambling is typically an “XOR” (exclusive-or) operation between the clear data DatClr and a pseudo-random dataset, typically obtained with a Linear Feedback Shift Register (LFSR).

The pseudo-random dataset generated by an LFSR is characterized by the retroaction polynomial of the register LFSR, also called scrambling polynomial, and by an initialization value of the register LFSR.

The data DatBr thus encoded and scrambled are transmitted over the channel CNL, and the clear data may be retrieved by the XOR operation with the same pseudo-random dataset by the receiver Rx.

The receiver Rx includes in this regard a differential receiver DR receiving the data transferred over the channel CNL in series, of which are extracted a clock signal and a data signal by a clock and data recovery CDR circuit. The series of encrypted and encoded data is reorganized for a parallel communication DatBr, by a deserializer DeSrlzr circuit.

A line decoder LnDeCdr is configured to read the data DatBr according to the encoding of the channel CNL and to retrieve the raw, clear data DatClr.

The retrieval of clear data DatClr by the line decoder LnDeCdr includes the reverse operation of the scrambling operation, that is to say the same XOR operation with the same pseudo-random dataset LFSR.

The scrambling of the data transferred over the channel CNL makes it possible to randomize the content of the transmission DatBr in order to benefit particularly from:
a greater number of transitions in the flow of data transferred, to assist the recovery of the clock and reception data CDR;
a balancing of the quantity of 0 and of 1, to reduce the baseline wander on the channel CNL;
a reduction of repeated patterns making it possible to limit the electromagnetic disturbances; and
a confidentiality of the transferred content.

In order to protect against a confidentiality breach based on techniques for obtaining the scrambling polynomial and the initialization value, the communication between the transmitter Tx and the receiver Rx includes a procedure for securing and keeping secret the characteristics of the scrambling operation (that is to say the scrambling polynomial and the initialization value).

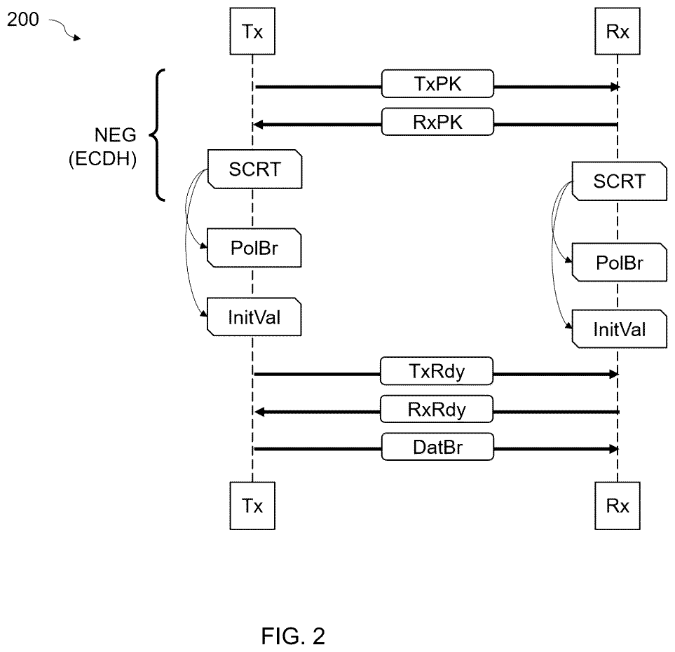

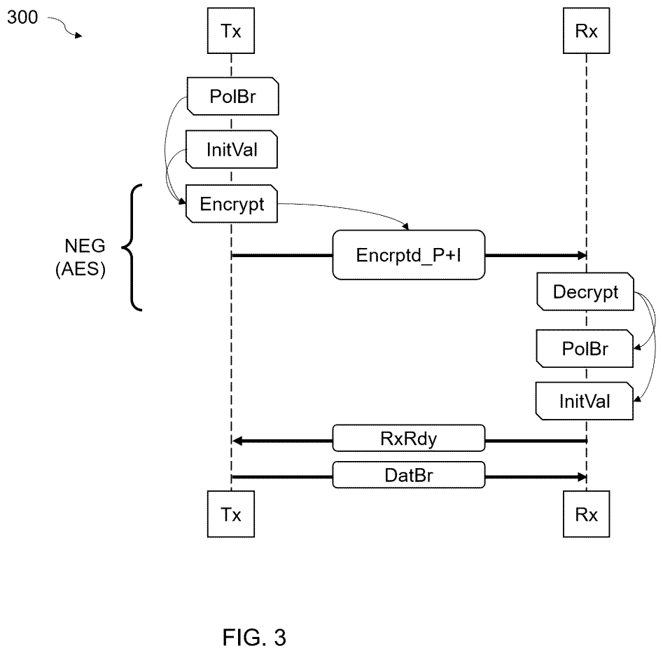

Thus, in this regard, the communication comprises a secret negotiation phase NEG (FIGS. 2 and 3) between the transmitter Tx and the receiver Rx to determine the scrambling polynomial PolBr (FIGS. 2 and 3) and the initialization value InitVal (FIGS. 2 and 3) used for scrambling and retrieving the data. The secret negotiation phase may be carried out specifically for each transmission over the channel CNL, or whenever N successive transmissions are carried out over the channel CNL (i.e., once every N transmissions).

A transmission may, for example, correspond to a session of the communication, including, for example, particularly a procedure for establishing the connection over the channel CNL, the data transfer strictly speaking, and a procedure for verifying and ending the transmission; typically according to the communication protocol used over the channel.

The secret negotiation phase may be carried out, for example, before the phase of transferring each transmission, or before the first phase of transferring the first of N successive transmissions, or during procedures for establishing the connection of each session.

The secret negotiation phase NEG may be controlled and executed by a software implementation in the transmitter Tx and receiver Rx devices, in order to give instructions to the line coder LnCdr belonging to the physical layer of the transmitter Tx and of the receiver Rx.

Reference is now made to FIGS. 2 and 3 that illustrate the communication methods 200, 300 in particular according to two examples of implementation of the secret negotiation phase NEG.

In the two examples 200, 300, it is particularly considered that the secret negotiation phase NEG includes an exchange of encrypted information between the transmitter Tx and the receiver Rx, the encrypted information making it possible to specifically determine the scrambling polynomial PolBr and the initialization value InitVal by the transmitter and by the receiver.

FIG. 2 illustrates a first example 200 of the method of communication between the transmitter Tx and the receiver Rx of the system 100 described above in relation to FIG. 1.

The method of communication 200 thus comprises at least one transmission of scrambled data DatBr with a pseudo-random sequence generated by a scrambling polynomial PolBr and an initialization value InitVal; as well as a secret negotiation phase NEG between the transmitter Tx and the receiver Rx, performed prior to the transmission, to specifically determine the scrambling polynomial PolBr and the initialization value InitVal for each transmission or each group of N transmissions.

The secret negotiation phase NEG of the first example 200 includes engaging in a Diffie-Hellmann key exchange ECDH, possibly based on elliptic curves, so as to develop a shared secret SCRT. The shared secret SCRT is a numerical value.

The shared secret SCRT, obtained in an identical manner by the transmitter Rx and by the receiver Tx, is used in order to determine the scrambling polynomial PolBr and the initialization value InitVal, specifically for this transmission or a group of N transmissions.

Indeed, summarily and conventionally and known per se, the Diffie-Hellmann key exchange makes it possible from a transfer of a public key from the transmitter TxPK to the receiver Rx and from a transfer of a public key from the receiver RxPK to the transmitter Tx, to construct the same shared secret SCRT by the transmitter Rx and by the receiver Tx, without ever communicating over the channel all of the parameters necessary for constructing the secret (particularly a combination of the public key of the transmitter TxPK received by the receiver Rx, with a private key of the receiver Rx; and a combination of the public key RxPK of the receiver Rx received by the transmitter Tx, with a private key of the transmitter Tx).

From the shared secret SCRT, thus developed in an identical manner by the transmitter Tx and the receiver Rx during the secret negotiation phase NEG, the scrambling polynomial PolBr and the initialization value InitVal specifically established for this transmission are determined.

For example, the scrambling polynomial PolBr is selected from a finite set of scrambling polynomials available to the transmitter Tx and to the receiver Rx. The selection is, for example, conditioned by numerical criteria arbitrarily established on the shared secret SCRT.

The scrambling polynomials belonging to said finite set available to the transmitter Tx and to the receiver Rx is hard coded, for example, that is to say in a static and physical layer of a circuit.

That said, many polynomials may be provided in the hard coding, and the shared secret SCRT makes it possible to choose one therefrom by applying conditions designed in advance in this regard, such as for example and arbitrarily:
For a set of 2 scrambling polynomials, one or the other can be selected according to the parity of the numerical value of the shared secret, that is to say according to the value 0 or 1 of the last low weight bit of the shared secret.
For a set of 3 (or other) scrambling polynomials, one of the polynomials can be selected depending on the respective interval of values wherein the first semi-byte of the shared secret is found (e.g., the scrambling polynomial no. 1 is selected if the semi-byte has a value located between 0x0 and 0x4; no. 2 if between 0x5 and 0x9; no. 3 if between 0xA and 0xF).
For a set of 2^{N} (two power N) scrambling polynomials, one of them can be selected according to the value of N bits drawn at an arbitrary position in the shared secret.

The same selection method can be used if the scrambling polynomial is implemented by software, here also chosen in a finite set of polynomials, pre-established and shared by the transmitter Tx and the receiver Rx.

On the other hand, the initialization value InitVal may be contained directly or indirectly in the shared secret SCRT.

Indeed, an initialization value InitVal can be chosen over N bits by directly selecting N bits in the shared secret, for example the last N low weight bits or the first N high weight bits of the shared secret.

The initialization value InitVal can also be obtained indirectly over N bits by techniques for deriving data read in a selection of N bits of the shared secret SCRT.

It will be noted that in such case 200, the shared secret SCRT may be considered as the encrypted information exchanged between the transmitter Tx and the receiver Rx, by the public key exchange mechanism TxPK, RxPK, the encrypted information SCRT making it possible to specifically determine the scrambling polynomial PolBr and the initialization value InitVal by the transmitter Tx and by the receiver Rx.

Finally, when the scrambling polynomial PolBr and the initialization value InitVal are determined by the transmitter Tx, the transmitter Tx can send a ready state signal TxRdy to the receiver Rx; and respectively in the same conditions, the receiver Rx can send a ready state signal RxRdy to the transmitter Tx.

When the two ready state signals are received on either side, then the transmission(s) of scrambled data DatBr can be carried out over the channel CNL.

FIG. 3 illustrates a second example 300 of the method of communication between the transmitter Tx and the receiver Rx of the system 100 described above in relation to FIG. 1.

The communication method 300 also comprises said at least one transmission of scrambled data DatBr; as well as a secret negotiation phase NEG.

The secret negotiation phase NEG of the second example 300 includes an encrypted communication AES, containing the determination of the scrambling polynomial PolBr and of the initialization value InitVal.

The encryption of the AES communication is advantageously of the Rijndael type (term used from a contraction of the names of its two creators, Joan Daemen and Vincent Rijmen), that is to say of the advanced encryption standard type.

Firstly, the scrambling polynomial PolBr is selected in advance by the transmitter Tx, here again for example in a finite set of scrambling polynomials available to the transmitter Tx and to the receiver Rx, potentially hard coded within the transmitter device Tx and the receiver device Rx.

Thus, the scrambling polynomial PolBr is, for example, chosen by way of a random selection in said finite set.

The same method can be used if the scrambling polynomial is implemented by software, here also chosen in a finite set of polynomials, shared by the transmitter Tx and the receiver Rx.

Likewise, the initialization value InitVal is obtained in advance by way of a random generation.

A random (or pseudo-random) data generator may be provided in the circuit of the transmitter, in a manner dedicated or not to these selection mechanisms.

When the determination of the scrambling polynomial PolBr and of the initialization value InitVal are thus obtained by the transmitter Tx, this information is encrypted Encrypt by the Rijndael algorithm and communicated Encryptd_P+I to the receiver Rx.

The receiver Rx is configured to decrypt Decrypt the encrypted information Encryptd_P+I thus received, so as to retrieve said determinations of the scrambling polynomial PolBr and of the initialization value InitVal randomly carried out in advance by the transmitter Tx.

The receiver Rx in this regard is provided with a decryption key corresponding to the AES encryption carried out by the transmitter Tx.

Thus, the encryption and decryption keys will be predetermined between the transmitter Tx and the receiver Rx, for example:
By being determined during the design phase and saved in the transmitter Tx and the receiver Rx. This applies in particular when the chips of the transmitter Tx and of the receiver Rx are in the same product (such as for example a processor Tx and a display Rx in the same product).
By being determined with the Diffie-Hellmann method described above, said keys being able to be derived from the shared secret. This applies in particular when the transmitter Tx and the receiver Rx do not know each other (such as for example a computer and a display, the two parts not sharing a design phase and not holding a shared key).

On the other hand, the initialization value InitVal may be contained directly or indirectly in the encrypted information.

Indeed, the initialization value InitVal can be transmitted directly in the encrypted information Encryptd_P+I, and the initialization value InitVal can also be deduced indirectly by techniques for deriving the content of the encrypted information Encryptd_P+I (although there is little interest in combining a derivation technique in addition to the advanced encryption standard, given the safety of the latter).

It will be noted that in such case 300, the encrypted information Encryptd_P+I exchanged between the transmitter Tx and the receiver Rx, make it possible for the receiver Rx to specifically determine the scrambling polynomial PolBr and the initialization value InitVal, determined in advance and by the transmitter Tx.

Finally, when the scrambling polynomial PolBr and the initialization value InitVal are determined by the receiver Rx, the receiver Rx can send a ready state signal RxRdy to the transmitter Tx; by considering that sending encrypted information Encryptd_P+I implicitly communicates a ready state of the transmitter Tx.

When the transmitter Tx and the receiver Rx are in the ready state, then the transmission(s) of scrambled data DatBr can be carried out over the channel CNL.

In summary, it has been described examples of embodiments and implementations of a secret negotiation technique NEG of the scrambling polynomial PolBr and of the initialization value InivtVal between a transmitter device Tx and a receiver device Rx, without transmitting these clear values over the channel CNL.

Consequently, the use of scrambling in the coding of data according to these examples of embodiments and implementations, is not vulnerable to sniffing and killer packet attacks.

Furthermore, the invention is not limited to these examples of embodiments and implementations, but encompasses all variants, and may be provided in all applications where scrambling is used, particularly chip-to-chip communications, but also in memory controllers that back up scrambled data in the memories, and without strictly restricting the transmitter and receiver functions, a transmitter of a communication being able to be the receiver of another and vice-versa.

1. A method of communication between a transmitter and a receiver, comprising:
performing a secret negotiation phase between the transmitter and the receiver to specifically determine a scrambling polynomial and an initialization value for at least one transmission between the transmitter and the receiver; and
then engaging in at least one transmission of scrambled data with a pseudo-random sequence generated by the scrambling polynomial and the initialization value.

2. The method according to claim 1, wherein performing the secret negotiation phase comprises exchanging encrypted information between the transmitter and the receiver, said encrypted information configured to make it possible to specifically determine the scrambling polynomial and the initialization value by the transmitter and by the receiver.

3. The method according to claim 2, further comprising determining the scrambling polynomial by selecting from a finite set of scrambling polynomials available to the transmitter and to the receiver, wherein selecting depends on conditions contained in said encrypted information.

4. The method according to claim 2, further comprising containing the initialization value directly in said encrypted information.

5. The method according to claim 2, further comprising containing the initialization value indirectly in said encrypted information.

6. The method according to claim 1, wherein performing the secret negotiation phase comprises engaging in a Diffie-Hellmann key exchange so as to develop a shared secret, and further comprising determining the scrambling polynomial and the initialization value by the transmitter and by the receiver using the shared secret.

7. The method according to claim 1, wherein performing the secret negotiation phase comprises transmitting an encrypted communication of the Rijndael type containing the determination of the scrambling polynomial and of the initialization value.

8. A system, comprising:
a transmitter; and
a receiver;
wherein the transmitter and the receiver are configured to:
perform a secret negotiation phase to specifically determine a scrambling polynomial and an initialization value for at least one transmission; and
then implement a communication comprising at least one transmission of scrambled data with a pseudo-random sequence generated by the scrambling polynomial and the initialization value.

9. The system according to claim 8, wherein the transmitter and the receiver are configured, in the secret negotiation phase, to exchange encrypted information making it possible to specifically determine, by each of the transmitter and the receiver, the scrambling polynomial and the initialization value.

10. The system according to claim 9, wherein a finite set of scrambling polynomials are available to each of the transmitter and the receiver, and wherein the transmitter and the receiver determine the scrambling polynomial by selecting from the finite set depending on conditions contained in said encrypted information.

11. The system according to claim 9, wherein the transmitter and the receiver are configured to exchange said encrypted information directly containing the initialization value.

12. The system according to claim 9, wherein the transmitter and the receiver are configured to exchange said encrypted information indirectly containing the initialization value.

13. The system according to claim 8, wherein the secret negotiation phase performed by the transmitter and the receiver comprises a Diffie-Hellmann key exchange performed to develop a shared secret from which the scrambling polynomial and the initialization value are determined.

14. The system according to claim 8, wherein the transmitter and the receiver are configured, in the secret negotiation phase, to carry out an encrypted communication of the Rijndael type containing the determination of the scrambling polynomial and of the initialization value.

15. A transmitter device, configured to implement a communication, with a receiver, comprising at least one transmission of scrambled data with a pseudo-random sequence generated by a scrambling polynomial and an initialization value, wherein the transmitter device is configured to engage in a secret negotiation phase with the receiver, prior to engaging in the at least one transmission of scrambled data, to specifically determine the scrambling polynomial and the initialization value for said at least one transmission.

16. The transmitter device according to claim 15, wherein engaging in the secret negotiation phase comprises: selection of the scrambling polynomial and the initialization value by the transmitter device; encryption of the scrambling polynomial and the initialization value in an encrypted communication; and sending of the encrypted communication to the receiver, where the receiver can determine the scrambling polynomial and the initialization value from a decryption of the encrypted communication.

17. The transmitter device according to claim 16, wherein the encrypted communication is of the Rijndael type.

18. The transmitter device according to claim 15, wherein engaging in the secret negotiation phase comprises: engaging in a communication exchange with the receiver to determine a shared secret; and selecting the scrambling polynomial and the initialization value using the shared secret.

19. The transmitter device according to claim 18, wherein engaging in the communication exchange comprises performing a Diffie-Hellmann key exchange to develop the shared secret from which the scrambling polynomial and the initialization value are determined.

20. A receiver device configured to implement a communication, with a transmitter, comprising at least one transmission of scrambled data with a pseudo-random sequence generated by a scrambling polynomial and an initialization value, wherein the receiver device is configured to engage in a secret negotiation phase with the transmitter to specifically determine the scrambling polynomial and the initialization value for said at least one transmission.

21. The receiver device according to claim 20, wherein engaging in the secret negotiation phase comprises: receiving an encrypted communication from the transmitter which includes a transmitter selected scrambling polynomial and initialization value; and decrypting the encrypted communication to obtain the scrambling polynomial and the initialization value.

22. The receiver device according to claim 21, wherein the encrypted communication is of the Rijndael type.

23. The receiver device according to claim 20, wherein engaging in the secret negotiation phase comprises: engaging in a communication exchange with the transmitter to determine a shared secret; and selecting the scrambling polynomial and the initialization value using the shared secret.

24. The receiver device according to claim 23, wherein engaging in the communication exchange comprises performing a Diffie-Hellmann key exchange to develop the shared secret from which the scrambling polynomial and the initialization value are determined.
